(19) United States
(12) Patent Application Publication
(10) Pub. No.: US 2026/0181238 A1
(43) Pub. Date: Jun. 25, 2026

(54) ILLUMINATING DEVICE COMPRISING A LIGHT SOURCE AND AN OPTICAL REFLECTOR, AND ASSOCIATED ELECTRONIC DEVICE

(71) Applicant: VALEO COMFORT AND DRIVING ASSISTANCE, Créteil (FR)

(72) Inventors: Tatiana Grulois, Creteil (FR); Hayk Yepremian, Creteil (FR)

(73) Assignee: VALEO COMFORT AND DRIVING ASSISTANCE, Créteil (FR)

(21) Appl. No.: 19/124,805

(22) PCT Filed: Sep. 27, 2023
(86) PCT No.: PCT/EP2023/076746

§ 371 Date: Apr. 25, 2025

(30) Foreign Application Priority Data
Oct. 25, 2022 (FR) 2211092

(51) Int. Cl. H04N 23/56; F21Y 115/10; H04N 23/74

(52) U.S. Cl. CPC H04N 23/56; H04N 23/74; F21Y 2115/10

(57) ABSTRACT

A lighting device includes a light source and an optical reflector. The light source includes a main direction of illumination which defines an optical axis. The optical reflector includes two segments, the first segment including a first wall which extends at least partially around the light source over a first height in the direction of the optical axis. The first wall is convergent in the direction of propagation of the light. The second segment includes a second reflective wall and extending in the continuation of the first wall over a second height in the direction of the optical axis so as to reflect light rays coming from the light source. The second wall is divergent in the direction of propagation of the light. An electronic device including the lighting device is also disclosed herein.

### TECHNICAL FIELD

The present invention relates to the technical field of imaging, and notably that of illuminating a scene observed by an image sensor.

The invention relates more particularly to an illuminating device comprising a light source and an optical reflector.

It also relates to an electronic device comprising an image-capture unit and such an illuminating device.

The invention finds a particularly advantageous application in the illumination of the interior of a motor vehicle for the benefit of the cameras that monitor the driver.

### TECHNOLOGICAL BACKGROUND

Increasingly frequently, use is being made of cameras that monitor the driver in a motor vehicle interior, better known by their abbreviation DMS which stands for Driver Monitoring Systems. In this context in particular, it is known to couple an image-capture unit to an illuminating device in order to maintain a sufficient light level independently of the ambient light level.

The images captured by these devices are then analyzed by image-processing algorithms able to extract the pertinent information therefrom.

In order to improve the performance of the image-processing algorithms, the requirements regarding the quality of the images are becoming increasingly strict. One of the parameters for improving the quality of the captured images is the uniformity of the lighting of the scene that is produced by the illuminating device.

Conventionally, the light sources of the illuminating devices are made up of one or more LEDs operating in the infrared. LEDs generally have a Gaussian profile. The use of such light sources leads to non-uniform lighting of the vehicle interior.

In order to improve the performance of the current image-processing algorithms, it is recommended that the lighting of the scene should not exceed a contrast of around 20% over the field of view of the camera.

One solution for improving the uniformity of the lighting of a light source is to add an optical component such as a diffuser.

Nevertheless, this solution leads to a significant loss in light intensity, leading on to a loss of efficiency of the illuminating device and to a reduction in the quality of the captured images.

Another solution is to use a reflector surrounding the light source and able to reflect the peripheral rays from the source which lie outside of the field of the image-capture unit toward a zone of interest of the vehicle interior that does fall within the field of the image-capture unit in order to render the illumination more uniform.

This solution, although effective, leads to other sources of image impairment by redirecting parasitic light, notably rays having a very large angle of inclination on leaving the light source, as far as the image-capture unit.

### SUMMARY OF THE INVENTION

In this context, there is provided an illuminating device comprising a light source and an optical reflector, the light source having a main direction of lighting which defines an optical axis, and the optical reflector comprising two segments.

It is proposed here that the first segment should comprise a first wall which extends at least partially around the light source over a first height in the direction of the optical axis, the first wall being convergent in the direction of propagation of the light.

This first wall, on account of its convergence, makes it possible to avoid parasitic light being propagated into the illuminating device. Specifically, the rays emitted at the base of the light source and having a very large angle of inclination may be reflected (through specular or diffuse reflection) in the opposite direction from the direction of propagation of the light.

The second segment comprises a second wall which is reflective and extends in the continuation of the first wall over a second height in the direction of the optical axis so as to reflect light rays coming from the light source. The second wall is divergent in the direction of propagation of the light.

The second wall is able to reflect the peripheral light from the light source toward a zone of interest of the vehicle interior and thus create uniform illumination.

According to one embodiment, the optical reflector comprises a third segment comprising a reflective third wall which extends over a third height in the direction of the optical axis, in the continuation of the second wall of the second segment.

Moreover, the third wall of the third segment may have a third angle of inclination relative to the optical axis that is less than 5°.

In one embodiment, the first wall and the second wall of the optical reflector each comprise at least one pair of two faces.

Furthermore, the first wall and the second wall each comprise two pairs of two faces positioned such that the two faces of a pair face one another, one on each side of the light source.

The faces of the segments may be planar.

In one embodiment, the wall of the first segment of the optical reflector is reflective.

As a preference, the light source is an LED emitting in the infrared, and the walls of the segments are reflective in the infrared.

The invention also relates to an electronic device comprising an image-capture unit and an illuminating device as described hereinabove configured to illuminate the field of view of the image-capture unit.

The various features, variants and embodiments of the invention may be associated with one another in various combinations, provided that they are not mutually incompatible or exclusive.

### BRIEF DESCRIPTION OF THE FIGURES

In addition, various other features of the invention will become apparent from the accompanying description that is provided with reference to the drawings, which illustrate non-limiting embodiments of the invention, and in which:

FIG. 1 is a simulation of parasitic light within an electronic device as known from the prior art;

FIG. 2 is a functional schematic depiction, in cross section, of the illuminating device according to one embodiment of the invention;

FIG. 3 is a functional schematic depiction, in perspective, of the illuminating device of FIG. 2;

FIG. 4 is a functional schematic depiction of an electronic device comprising the illuminating device of FIG. 2;

FIG. 5 is a functional schematic depiction, in cross section, of the illuminating device according to an embodiment other than that of FIG. 2;

FIG. 6 is a simulation of the illumination generated by a conventional light source;

FIG. 7 is a simulation of the illumination generated by the illuminating device of FIG. 2; and

FIG. 8 is a graph indicating the mean and maximum lighting corresponding to the parasitic light entering the camera for the electronic device of FIG. 4 and for the electronic device of FIG. 1 as known from the prior art.

Note that, in these figures, structural and/or functional elements common to the various variants may have the same reference signs.

### DETAILED DESCRIPTION

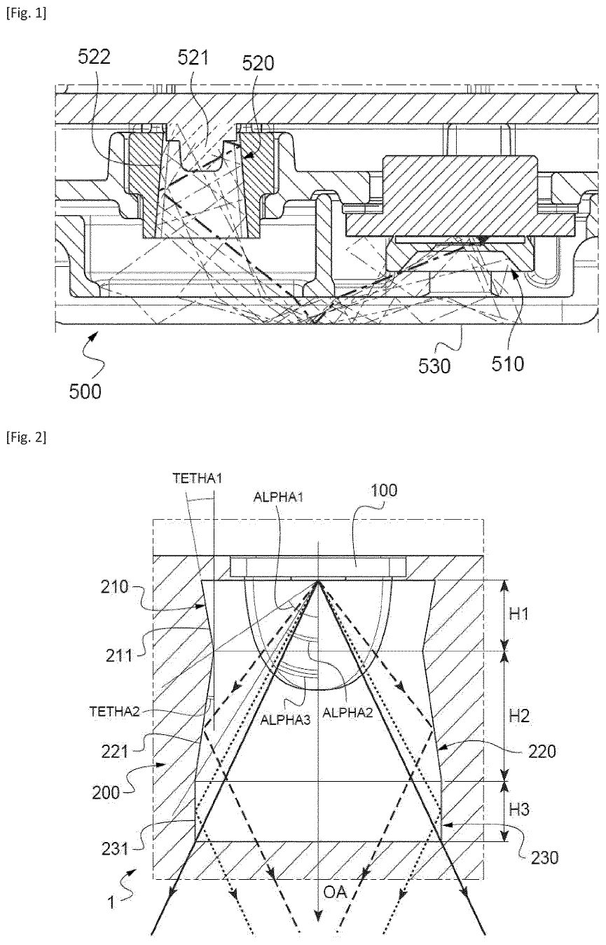

A conventional electronic device 500 for monitoring the driver in the interior of a vehicle as known from the prior art is depicted in FIG. 1. It comprises a conventional illuminating device 520, as known from the prior art, and an image-capture unit 510. The conventional illuminating device 520 comprises a light source 521 and a conventional optical reflector 522. In this instance, the light source 521 is an infrared LED. The conventional optical reflector 522 is a reflective wall of frustoconical shape which is continuous and surrounds the light source 521.

The image-capture unit 510 comprises a camera and is able to capture a scene illuminated by the conventional illuminating device 520. The conventional electronic device 520 also comprises a protective outer lens 530. This protective outer lens may be made of glass or of plastic.

FIG. 1 depicts parasitic rays of light. The parasitic rays of light comprise the light rays emitted by the light source 521 and arriving at the image-capture unit 510 without having illuminated the scene.

The majority of the parasitic light rays are rays that are reflected off the inside of the outer lens 530 of the conventional electronic device 500 to reach the image-capture unit 510 without being able to exit the conventional electronic device 500.

Simulation of these rays demonstrates that a large majority of these parasitic light rays are rays with a very large angle of inclination as they exit the light source 521 and are reflected by the conventional optical reflector 522 in its portion closest to the light source.

This fraction of the illumination contributes little to the illumination of the scene and therefore generates more by way of loss of uniformity on account of the parasitic rays than it generates by way of additional illumination.

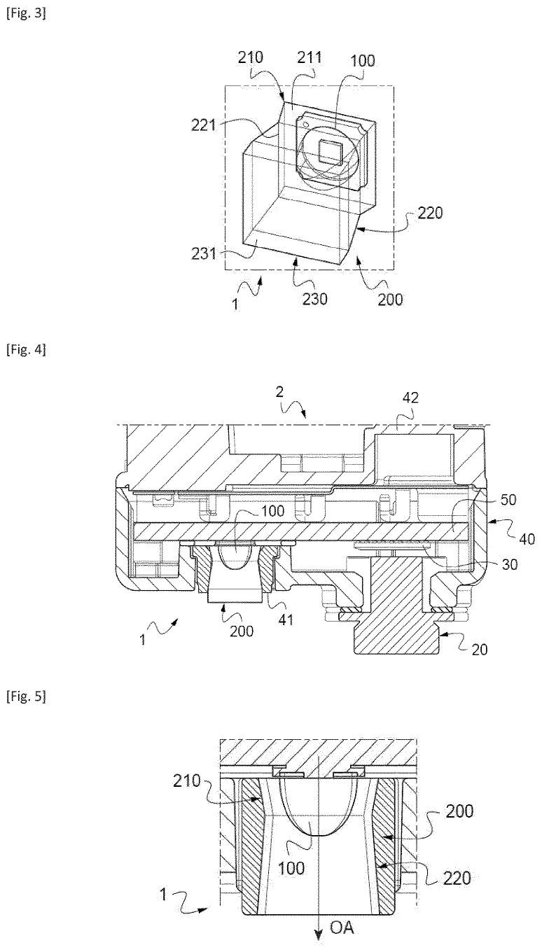

An illuminating device 1 according to one embodiment proposed by the invention is depicted in cross section in FIG. 2. This device comprises a light source 100 and an optical reflector 200. This same illuminating device 1 is depicted in perspective in FIG. 3.

The light source 100 may for example be an LED. The light source 100 defines an optical axis OA. The optical axis OA is the main direction of lighting of the light source, namely for example the direction in which the luminous intensity is at its maximum. The reflector may be oriented in such a way that its main axis coincides with the optical axis OA.

The optical reflector 200 here comprises a first segment 210, a second segment 220 and a third segment 230.

The first segment 210, closest to the light source 100, comprises a first wall 211. The first wall 211 comprises four faces surrounding the light source 100 and facing one another in pairs.

The faces in this instance are planar. They may be of trapezoidal shape.

The faces are inclined in such a way that the surface defined by the first segment 210 (in section orthogonal to the optical axis OA) decreases in the direction of propagation of the light. In other words, the faces converge toward the optical axis in the direction of propagation of light. The faces may be symmetrical about the optical axis OA.

A first angle of inclination THETA1 is defined as being the angle of inclination of the faces of the first segment 210 with respect to the optical axis OA.

The faces in this instance are reflective. In this way, the rays emanating from the light source 100 at a very large angle of inclination, such as those that create parasitic light in the example of FIG. 1, will be reflected in the opposite direction from the direction in which the light is propagated, toward the light source 100 itself. For example, the reflection in this instance is specular reflection.

Thus, when used with an image-capture unit as described hereinbelow with reference to FIG. 4, the parasitic light will not exit the illuminating device 1 and will therefore not be propagated as far as the image-capture unit.

The faces are reflective at least in the range of wavelengths emitted by the light source 100 and/or in the range of wavelengths of the image-capture unit. In this instance, the faces are reflective at least in the infrared.

The rays with a very large angle of inclination are defined as being those rays that make, with the optical axis, an angle of between an angle ALPHA1 and 90°. The angle ALPHA1 is the angle between the optical axis OA and the ray furthest distant from the optical axis OA that is not reflected by the first segment 210.

In another embodiment, the reflection of the light off the first segment is diffuse reflection.

Alternatively, the faces may be absorbent in the range of wavelengths emitted by the light source 100. In that case, the rays are absorbed and not propagated as far as the image-capture unit.

The second segment 220 extends in continuity with the first segment 210. The second segment 220 comprises a second wall 221. The second wall 221 comprises four reflective faces each of which extends in continuity with a corresponding face of the first segment 210. The faces are arranged in two pairs. In each of the pairs, the faces are positioned facing one another.

The faces in this instance are planar. They may be of trapezoidal shape.

Unlike in the first segment 210, the faces are inclined in such a way that the surface defined by the second segment 220 (in section orthogonal to the optical axis OA) increases in the direction of propagation of the light. In other words, the faces diverge away from the optical axis in the direction of propagation of the light.

A second angle of inclination THETA2 is defined as being the angle of inclination of the faces of the second segment 220 with respect to the optical axis OA. The first angle of inclination THETA1 and the second angle of inclination THETA2 are of opposite signs.

This second segment 220 reflects some of the rays originating from the light source 100 and forming with the optical axis an angle comprised between ALPHA1 and an angle ALPHA2. The angle ALPHA2 is defined as being the angle between the optical axis OA and the ray furthest distant from the optical axis OA that is not reflected by the second segment.

The third segment 230 extends in continuity with the second segment 220. The third segment 230 comprises a third wall 231. The third wall 231 of the third segment 230 comprises four faces each of which extends in continuity with a corresponding face of the second segment 220. The faces are arranged in two pairs. In each of the pairs, the faces are positioned facing one another.

The faces in this instance are planar. They may be of trapezoidal shape.

A third angle of inclination is defined as being the angle of inclination of the faces of the third segment 230 with respect to the optical axis OA.

This third segment 230 reflects some of the rays originating from the light source 100 and forming with the optical axis an angle comprised between ALPHA2 and an angle ALPHA3. The angle ALPHA3 is defined as being the angle between the optical axis OA and the ray furthest distant from the optical axis OA that is not reflected by the third segment 230.

For example, for a light source emitting a cone of emitted light that makes an angle of between 50° and 80° with the optical axis, the angle ALPHA1 may be comprised between 55° and 65° and/or the angle ALPHA2 may be comprised between 32° and 48° and/or the angle ALPHA3 may be comprised between 25° and 40°.

The faces of the second segment 220 and/or third segment 230 are in this instance reflective in the infrared.

The second segment 220 and the third segment 230 make it possible to create more uniform lighting by reflecting the rays of greatest angle of inclination that do not lie in the field of view of the image-capture unit toward zones of interest in the field of view of the image-capture unit that lack adequate lighting.

For example, in the case of a Gaussian light source 100, which is the case of the LED used here, the outermost rays are reflected toward the peripheral zones of the central spike of lighting or the edges of the field of view of the image-capture unit.

Several light rays originating from the light source 100 may be seen in FIG. 2. The rays depicted in solid line have an angle of inclination that is smaller than ALPHA3 and are not reflected. The light rays depicted in dotted line are reflected by the second segment 220. The reflected rays depicted in dashed line are reflected by the third segment 230. The rays depicted in dashed line and in dotted line will thus make it possible to compensate for the Gaussian distribution of the LED by returning some luminous flux to the edges of the field of view.

Moreover, the optical reflector 200 may be produced using standard industrial processes such as injection molding followed by the deposition of a reflective coating using physical vapor deposition (PVD) or galvanizing.

FIG. 4 depicts an electronic device 2 according to one embodiment of the invention. The electronic device 2 comprises the illuminating device 1 of FIGS. 2 and 3 and described hereinabove. It also comprises an image-capture unit 20 and a control unit 30 coupled to the illuminating device 1 and to the image-capture unit 20. The electronic device 2 may be placed in a motor vehicle, for example in order to form a driver monitoring system.

The image-capture unit 20 makes it possible to capture images of an environment facing it, in this instance part of the interior of the motor vehicle. For example, the field of view of the image-capture unit 20 is directed toward the usual position of the driver. The image-capture unit 20 may be a camera and capture the entire scene lit by the illuminating device 1. The control unit 30 is configured to analyze the captured image.

The control unit may be designed to determine (when the driver is in the usual driving position) a level of unfitness to drive (for example a level of distraction or a level of sleepiness) by means of analysis of the captured image.

In order to avoid discomforting persons present near the electronic device and to make the image-capture process the same both day and night, the light source 100 may operate in the infrared as infrared light is invisible to the human eye. The image-capture unit 20 operates at least in the same wavelength range as the light source 100. In this instance, the image-capture unit 20 operates solely in the infrared. As an alternative, the image-capture unit may operate in the infrared and in the visible.

In order to improve the performance of the process of analyzing the captured image, it is preferable for the uniformity of lighting to be such that the lighting contrast is below 20%. That means that two points in the field of view of the image-capture unit 20 must receive a difference in lighting that is less than 20%.

The angles of inclination and the heights of the faces of the segments have been calculated by numerical simulation in order to meet this objective.

The first segment 210 may have a first height H1 along the optical axis that is comprised between 1 and 1.5 mm. In this instance, the first height H1 is 1.3 mm. The absolute value of the first angle of inclination THETA1 of the first segment 210 with respect to the optical axis (OA) may be comprised between 8 and 15°. In this instance, the absolute value of the first angle of inclination is 10°.

The second segment 220 may have a second height H2 along the optical axis that is comprised between 2 and 5 mm. In this instance, the second height H2 is 3 mm. The absolute value of the second angle of inclination THETA2 of the second segment 220 with respect to the optical axis (OA) may be comprised between 8 and 15°. In this instance, the absolute value of the second angle of inclination is 10°.

The third segment 230 may have a third height H3 along the optical axis that is comprised between 0.8 and 1.5 mm. In this instance, the third height H3 is 1 mm. The absolute value of the third angle of inclination of the third segment 230 with respect to the optical axis (OA) may be less than 5°. In this instance, the absolute value of the third angle of inclination is 1°.

For better results regarding the uniformity of the source, the inclination of the faces of the third segment 230 may be zero. However, in order to make the optical reflector 200, which is generally molded, easier to manufacture, it is preferable for the faces of the third segment 230 to be slightly inclined.

These values are dependent on the light source 100 and on the configuration of the image-capture unit 20. They are given here by way of nonlimiting indication.

The electronic device 2 in this instance comprises an outer casing 40 and a removable cover 42. The outer casing 40 holds the elements mechanically relative to one another. The removable cover 42 provides easy access to the inside of the electronic device 2.

The electronic device 2 also comprises a printed circuit 50 to which the light source 100 and the control unit 30 are attached. The optical reflector 200 in this instance is attached using securing clips 41.

As a variant, the illuminating device 1 could be fully attached directly to the printed circuit 50.

FIG. 5 depicts an illuminating device 1 according to another embodiment of the invention. The illuminating device 1 in this instance comprises a light source 100 and an optical reflector 200. The light source 100 may be a source with Gaussian illumination, such as an LED for example. The optical reflector 200 in this instance comprises two segments.

The first segment 210 has convergent faces and limits the propagation of parasitic light. The second segment 220 has divergent faces and makes the illumination more uniform in the same way as was described hereinabove.

FIG. 6 depicts a simulation 110 of the illumination generated by the light source 100 used in the illuminating device 1. A Gaussian distribution of the light may be seen.

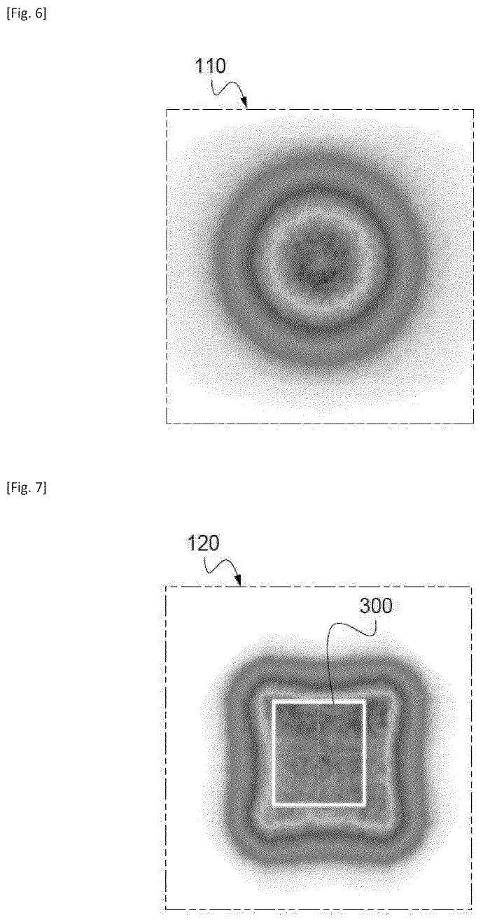

FIG. 7 depicts a second simulation 120 of the illumination generated by the illuminating device 1 of FIG. 2. Thanks to the optical reflector 200, the peripheral light rays are bent back around the light spike, thus generating lighting that is uniform over a wider field of view.

FIG. 7 indicates a zone 300 (usually termed “headbox”) corresponding to the possible location of the driver's head. It may be seen that the lighting simulated here is uniform over a field of view that is broad enough to fully light the aforementioned zone 300.

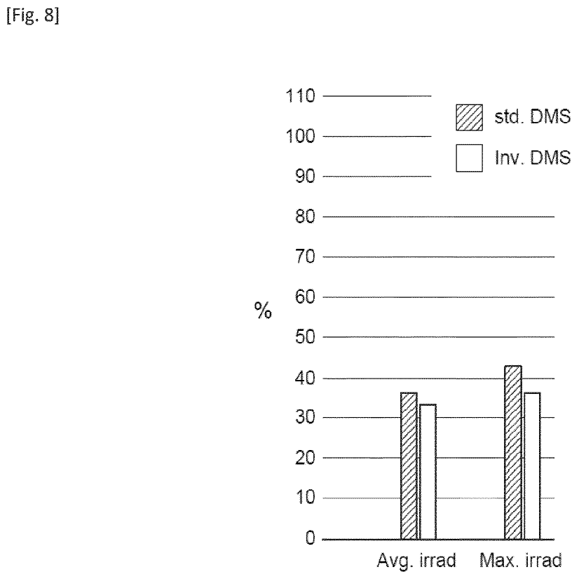

FIG. 8 is a graph showing the mean lighting (Avg. Irrad) and maximum lighting (Max. Irrad) caused by the parasitic light as a percentage with respect to a standard value entering a camera for the electronic device of FIG. 4 (Inv. DMS) and for the conventional electronic device of FIG. 1 comprising a conventional illuminating device (Std. DMS).

It may be seen that there is a smaller amount of parasitic light when using the electronic device of FIG. 4 and as defined here than when using the conventional electronic device of FIG. 1 comprising a conventional illuminating device.

1. An illuminating device comprising a light source; and an optical reflector, the light source having a main direction of lighting which defines an optical axis, the optical reflector comprising two segments,
wherein the first segment comprising a first wall which extends at least partially around the light source over a first height in the direction of the optical axis, the first wall is convergent in the direction of propagation of the light,
wherein the second segment comprising a second wall which is reflective and extends in a continuation of the first wall over a second height in the direction of the optical axis so as to reflect light rays coming from the light source, the second wall is divergent in the direction of propagation of the light.

2. The illuminating device as claimed in claim 1, wherein the optical reflector comprises a third segment comprising a reflective third wall which extends over a third height in the direction of the optical axis, in the continuation of the second wall of the second segment.

3. The illuminating device as claimed in claim 2, wherein the third wall of the third segment has a third angle of inclination relative to the optical axis that is less than 5°.

4. The illuminating device as claimed in claim 1, wherein the first wall and the second wall of the optical reflector each comprise at least one pair of two faces.

5. The illuminating device as claimed in claim 4, wherein the first wall and the second wall each comprise two pairs of two faces positioned such that the two faces of a pair face one another, one on each side of the light source (100).

6. The illuminating device as claimed in claim 4, wherein the faces are planar.

7. The illuminating device as claimed in claim 1, wherein the first wall of the first segment of the optical reflector is reflective.

8. The illuminating device as claimed in claim 1, wherein the light source is an LED emitting in the infrared, and wherein the walls of the segments are reflective in the infrared.

9. An electronic device comprising an image-capture unit and the illuminating device as claimed in claim 1 configured to illuminate the field of view of the image-capture unit.
